(19) United States
(12) Patent Application Publication
(10) Pub. No.: US 2019/0272416 A1
(43) Pub. Date: Sep. 5, 2019

(54) Improved delivery and automation of pre-stored data to an OCR acquired endpoint by various electronic transmission mediums from a mobile electronic device.

(71) Applicant: Jerry Clifford Johnson, SAINT LOUIS, MO (US)

(72) Inventor: Jerry Clifford Johnson, SAINT LOUIS, MO (US)

(21) Appl. No.: 16/288,111

(22) Filed: Feb. 28, 2019

Related U.S. Application Data
(60) Provisional application No. 62/637,953, filed on Mar. 2, 2018.

(51) Int. Cl. G06K 9/00; G06K 9/62

(52) U.S. Cl. CPC G06K 9/00442; G06K 2209/01; G06K 9/6201

(57) ABSTRACT

A method for delivering digital information to an image acquired endpoint with minimal time and effort used during the capturing and transferring phase of the process by way of an electronic mobile device. An image is acquired and processed with character recognition software. The derived information is tested against common patterns, categorized, and displayed to the user. On confirmation from the user, prestored information is then sent back to the endpoint acquired from the image scanned. All derived information is then forwarded to a database for future use. As a result, the process of sharing and capturing of data by a user is improved in speed of use, accuracy, and options for data manipulation Other embodiments are described as shown.

### CROSS-REFERENCE TO RELATED APPLICATIONS

This application claims the benefit of provisional patent application Ser. No. 62/637,953, filed 2018 Mar. 2 by the present inventors.

### FEDERALLY SPONSORED RESEARCH

nonapplicable

### SEQUENCE LISTING OR PROGRAM

nonapplicable

### TECHNICAL FIELD

This application relates to electronic business cards, particularly to sharing of an electronic business card.

### BACKGROUND ART

Throughout the years there have been many improvements and customs created in the way data sharing plays out in the business world. In this data-driven age most business persons are starting to use databases to keep track of all of their contacts, and many are even starting to use Customer Relationship Management (CRM) software to automate the task of maintaining relevant relationships with the people that they meet. Some of the issues that have arisen in today's digital world is that the sharing of business information is still mostly achieved with physical business cards. Physical business cards are great in that they are cheap, easy to carry, and easily handed off to the interested party. One issue that arises, however, is that all collected information needs to be transferred into a digital format. Optical Character Recognition (OCR) technology has come a long way in solving this problem with patents such as U.S. Pat. No. 6,038,342A to Bernzott, Aug. 10, 1988 and CN108596167A to [symbol] , Apr. 19, 2018, along with numerous others. A document can be scanned and interpreted into a digital representation of the data that can then be added to a database for further actions. Other limitations of using physical business cards are that users have the potential to run out of cards or forget to bring them to an encounter, or even worse, the information contained on a physical card becomes outdated and then the whole card is irrelevant. Digital versions of business cards are a great way to have a card at all times to share as needed. They are also a great way to keep up with changing information. For all the advantages that digital cards have over their paper counterparts, new issues and challenges have now been created.

Digital business cards are currently shared by asking recipients for their email address, phone number, or other form of communication and then manually typing that information into the sharing platform on their digital card, for sending their information to the recipient. This does work, but in a business environment the time it takes to complete the task interrupts the flow of conversation, creates an awkward first impression, and reduces the number of people or prospects that a person can interact with during a networking session. U.S. Pat. No. 5,818,442A, Adamson, 1996, provides a way for faster transfer of digital to digital cards but does not address other scenarios.

One solution tries to speed up this process by embedding a barcode or QR code of some type that allows the recipient to use their mobile device to scan and receive the digital business card. Most people, however, are not familiar enough with their own mobile devices, let alone the barcode scanning technology, to be able to use this method without considerable help or coaching.

Another method requires the recipient to type their own email into a form field, after which the digital card is sent to them, which also disrupts the flow of the interaction, and requires manual work later to type in the remainder of the contact information. Also, email open rates are notoriously low.

Paper business cards can be shared in under three seconds, versus 11 seconds for a digital business card swap, according to one blogger who was presenting the advantages of paper business cards over their digital counterparts. According to Forbes and other online business sites, paper cards still hold a unique advantage over their digital rival: the ease, simplicity, and speed of transferring information. It is with respect to these and other considerations that the present invention has been made.

### BRIEF SUMMARY OF THE INVENTION

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

A basic embodiment of the invention is a program that facilitates the faster and simpler exchange of information between two parties with one party displaying information that can be photographed and the other party having a mobile electronic device with stored data. This process reduces the time it takes to share back the stored data to a valid endpoint derived from the photo.

The program reads a paper document or digital display using the camera on a mobile device, deducing the mobile number on document, and then auto-sending pre-selected information back to the captured mobile number. This reduces the time it takes to trade information considerably, thereby making the process much more smooth, professional, and leaving a better first impression. It also digitizes vital information more quickly and permanently, reducing the possibility of losing valuable information in case a document is no longer available, and allows for notes to be added, or categorization to be made for later actions.

The program also allows the user to verify and edit the information instantly or at a later, more convenient time, which allows for a continuous exchange of information with other parties during the encounter. All of the documents' information can then be reviewed, edited, categorized, and uploaded to be used with the user's preferred database at a later time.

### DRAWINGS

FIG. 1a is a flow diagram illustrating the operational steps of an embodiment of the functions incorporated in the present invention;

FIG. 1b is a continuation of FIG. 1a;

FIG. 2a is an illustration of an embodiment that presents a business card as the document for which the present invention can be used;

FIG. 2b is an illustration of an embodiment that represents a business card being scanned by camera hardware highlighting the desired method by which to send stored data back to the document owner;

FIG. 2c is a mockup of the mobile device screen illustrating an embodiment of a document ready to scan;

FIG. 3 is a mockup of the mobile device screen illustrating the edit feature of an embodiment of the present invention;

FIG. 4 is a mockup of the mobile device screen illustrating captured data complete and ready for the next scan;

FIG. 5a is a flow diagram illustrating the operational steps of an alternate embodiment of the functions incorporated in the present invention;

FIG. 5b is a continuation of FIG. 5a;

### DETAILED DESCRIPTION

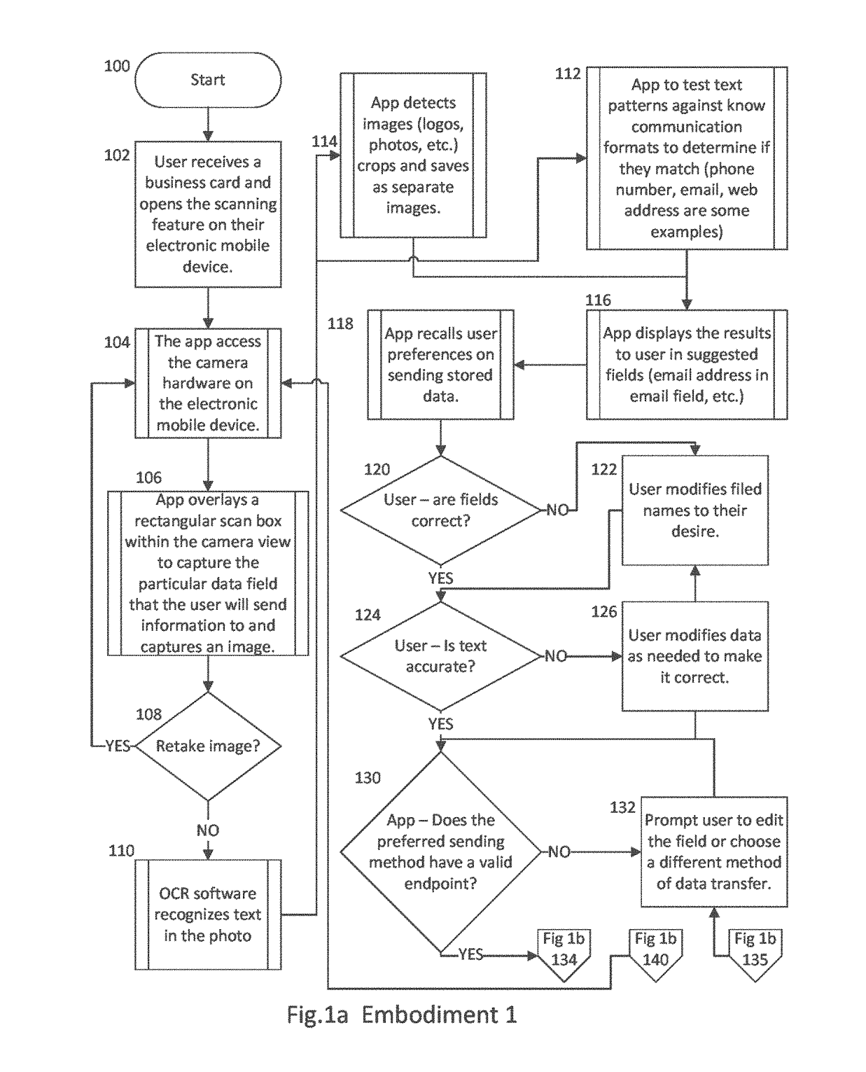

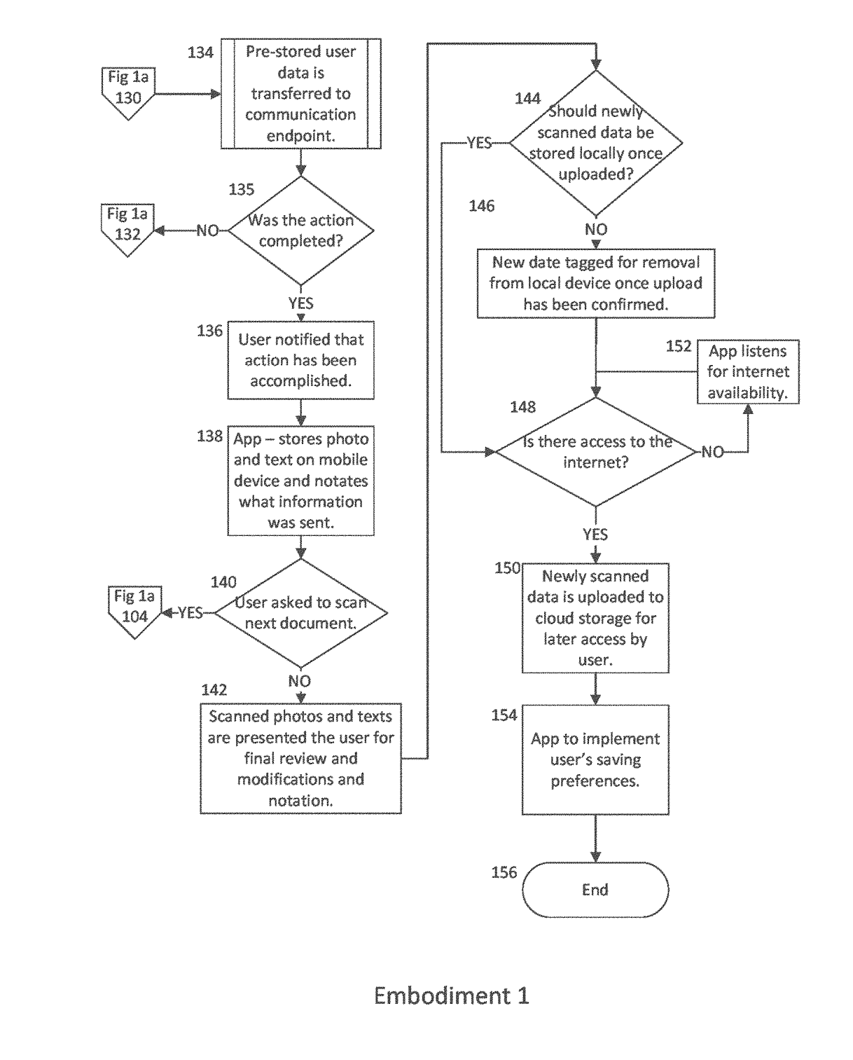

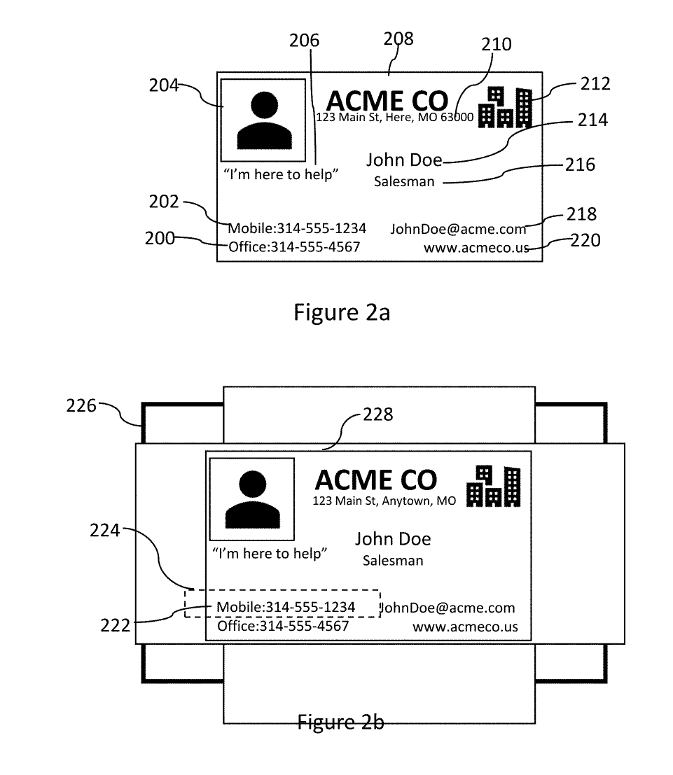

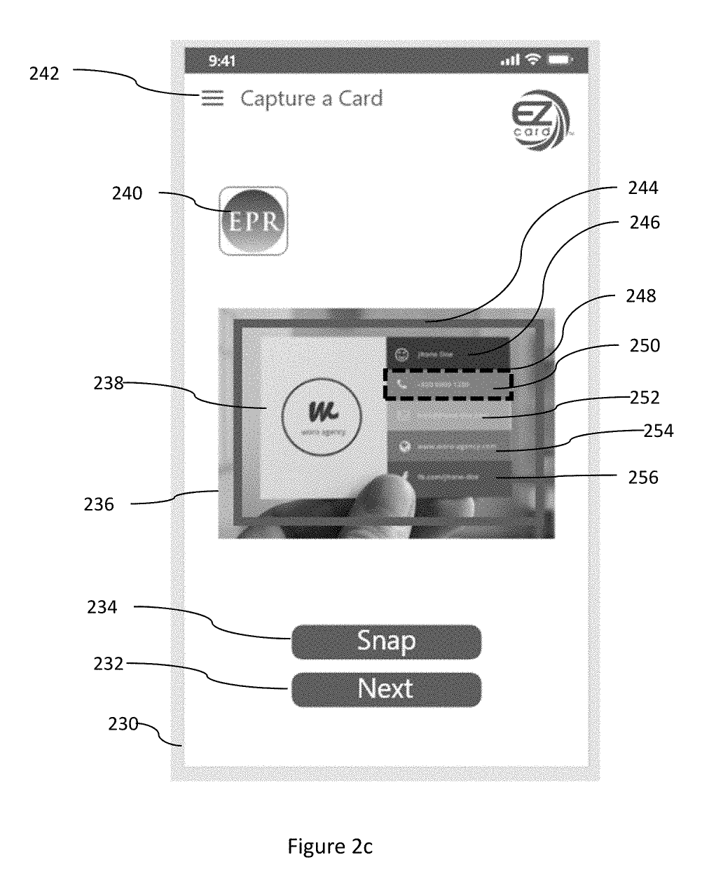

### First Embodiment—FIGS. 1-4

This is a narrative description of the structure of an embodiment. Sharing information in a business setting can be very difficult to do well. This embodiment facilitates a smoother and faster process by allowing a user to digitize hard copy documents that contain a communication channel and then automatically send their pre-stored information through the captured communication channel back. This reduces the time to trade information with someone and also reduces the time to add the captured information to an existing database for later use.

FIG. 1 In this present embodiment where the user is sharing digital information to another party that has a hard copy business card, element (100) starts the process. Prior to this step, the user has set up their defaults for this operation within the app. Choosing a predefined message to accompany the pre-stored information back to the other party, what their preferred method of sharing will be and what their default information will be that will be shared back to the other party.

The user can also choose what default category or tags the newly captured information will fall into. An example of this would be at a large business lunch where the purpose was to promote one of several products or businesses. The user would choose what information they plan to share by default, choose a label or tag for all new scanned information (tag=lunch group), choose the default category (category=contractors), choose the default communication platform (platform=text), choose to add a default note in the note field (note=contractor lunch March 2019).

In element (102), a user of the embodiment receives a business card (208) and (238) from another party during an encounter. The user then opens the app on their mobile device and chooses to scan the card. In element 104, the mobile devices then activates the camera on the device and displays the input (236) on the mobile device's screen. In element (106), the area of the information is outlined that is going to be captured (226) and (244).

The software displays an icon representing the digital information to be shared back to the business card owner (240). This icon is clickable to allow the user to choose a different stored data set to share instead. The user then aligns the business card (238) and (228) so that it fits within the usable area (226) and (244) and captures an image to be processed. Element (108), the image is taken with a click (234) and the software prompts the user to either retake the image (234) or process the existing image (232). In element (110), the software processes the image text upon selecting next (232). Then in element (112), the software tests the character patterns in the text against known stored patterns (phone number formats, email, name, web address, etc) and chooses the pattern that best matches what the user has chosen as a default sending endpoint. In element (114), areas of the scan that are not text, but are not blank, are considered as “image areas” (204), (212), and (238), the software captures in rectangle image areas (324, (326, and (428). Element (116) displays the processed information back to the user in fields to which it has determined the information should be connected. If the software can't categorize scanned data to known fields, example: (206), it saves that information in the notes section (346).

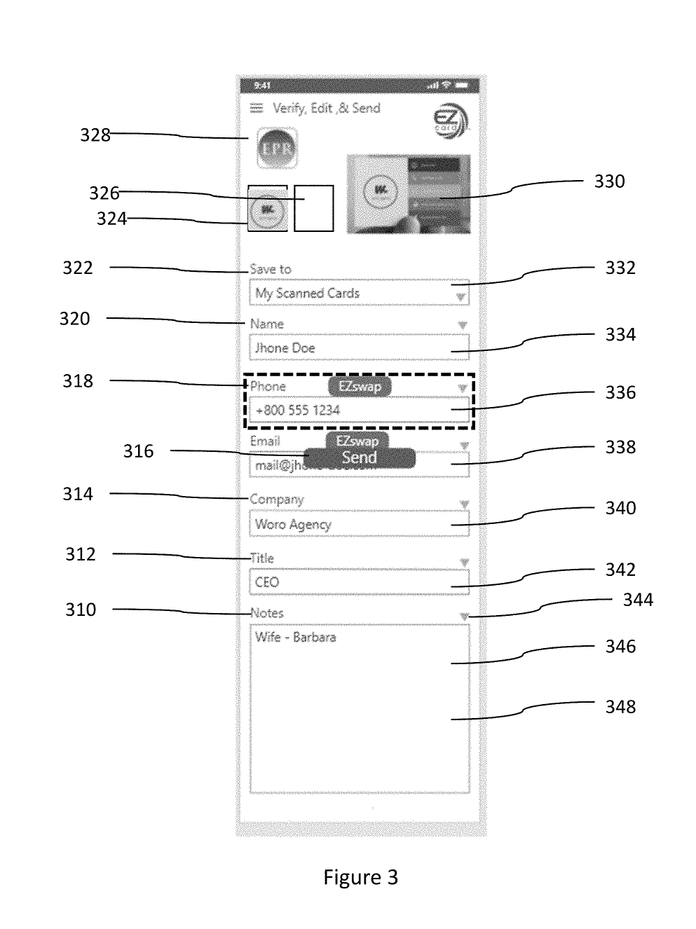

At element (118), the app recalls the user preferences on sending stored data and highlights the field that matches that request for easy viewing by the user (224) and (318). Elements (120-126) allows the user to verify, and if necessary, modify the information (FIG. 3). The default sending endpoint is highlighted for the user for easy reference (318). In element (122), the user is allowed to modify the field names as they desire (310-322). In element (126), the user is allowed to modify or correct the data that the software has scanned in from the image taken (332-346) and add a note to a notes field.

The app then verifies that the information in the preferred sending method is valid in element (130). If the information isn't valid, the user is requested to fix the selected issues in element (132). Depending on the method selected by the user, this part of the process, in element (134), can be accomplished in different ways noted later in different embodiments. In this embodiment, the software sends the user's data, represented to the user as an icon (432), via a text function (348). The software opens the mobile device's native texting platform and prefills the message with the user's date, and the “send to” field of the text is populated by the data acquired from the scan that is located in the field labeled mobile, cell, or phone (318). If it is unable to use the mobile devices built in texting ability, the software then send the data to the endpoint by way of alternative web-based solutions such as a texting service.

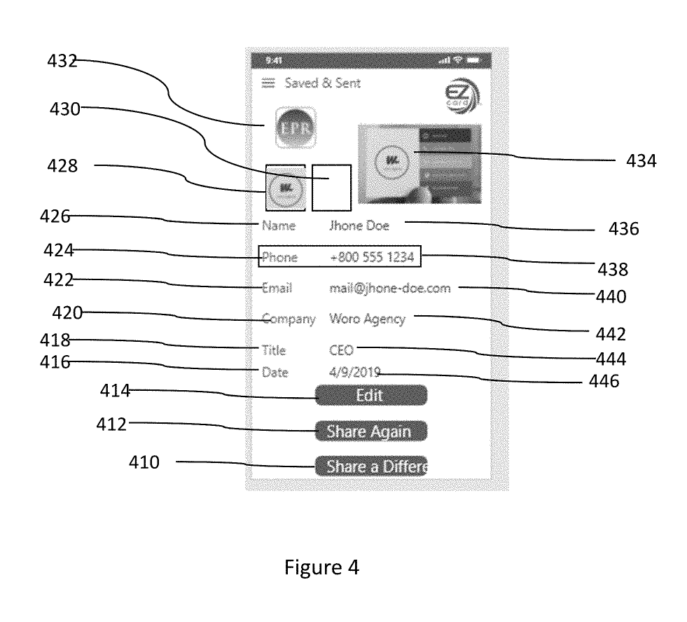

The software verifies that the action has been completed successfully in element (135), (FIG. 4). If the action was unsuccessful, it prompts the user to again edit in element (132) the information or choose another method (414). If the send was successful, the user is notified in element (136). The app then stores the date/time, method of communication, data sent, scanned text and images, and all other relevant data to the user's device for later retrieval in element (138). The software asks the user if they would like to scan the next document, giving the user the option to either share the same data set (412) or a different stored data set (410) in element (140).

If the user does want to scan another document, the process reverts back to element (104) and starts the process from there, otherwise, in element (142), the information stored in element (138) (416-446) is presented back to the user via the mobile device's interface for final review now that the user has time go into detail (FIG. 4). The user can now edit and/or modify the information (414).

The software then asks the user if they would like the new data (416-446) to be kept on the mobile device's local storage in element (146). If yes, the information is stored in the app's local database in the mobile device's internal storage; otherwise, the information is tagged to be removed once the data has been successfully uploaded to the cloud database. The mobile device searches available connection types (wifi, mobile carrier data, bluetooth, usb, etc to establish a connection to the internet in element (148) where it connects to the main cloud database and syncs all new information to the user's account in element (148). If a connection cannot be established, the software listens for when the connection is made available in element (152).

Newly scanned data is uploaded to the cloud storage for later access by the user in element (150). If the local data has been tagged for removal, the software now erases the data from the local device to save local resources; otherwise, the information is also stored locally per the user's preferences of internal storage or external storage including but not limited to a micro SD card for example in element (154). Element (156) ends the current embodiment's process.

### Additional Embodiment

The same methods in the first embodiment can be used for scanning documents other than business cards due to the fact that the software can be set up to validate other input fields specific for each application. Documents that are generally formatted can be used to program the software to identify fields and or patterned responses for capture in this system. For example, data from badges, tickets, forms, other documents, or displays that are generally consistent in formatting, can be easily programmed as long as they have a valid endpoint to send information to electronically.

### Additional Embodiment

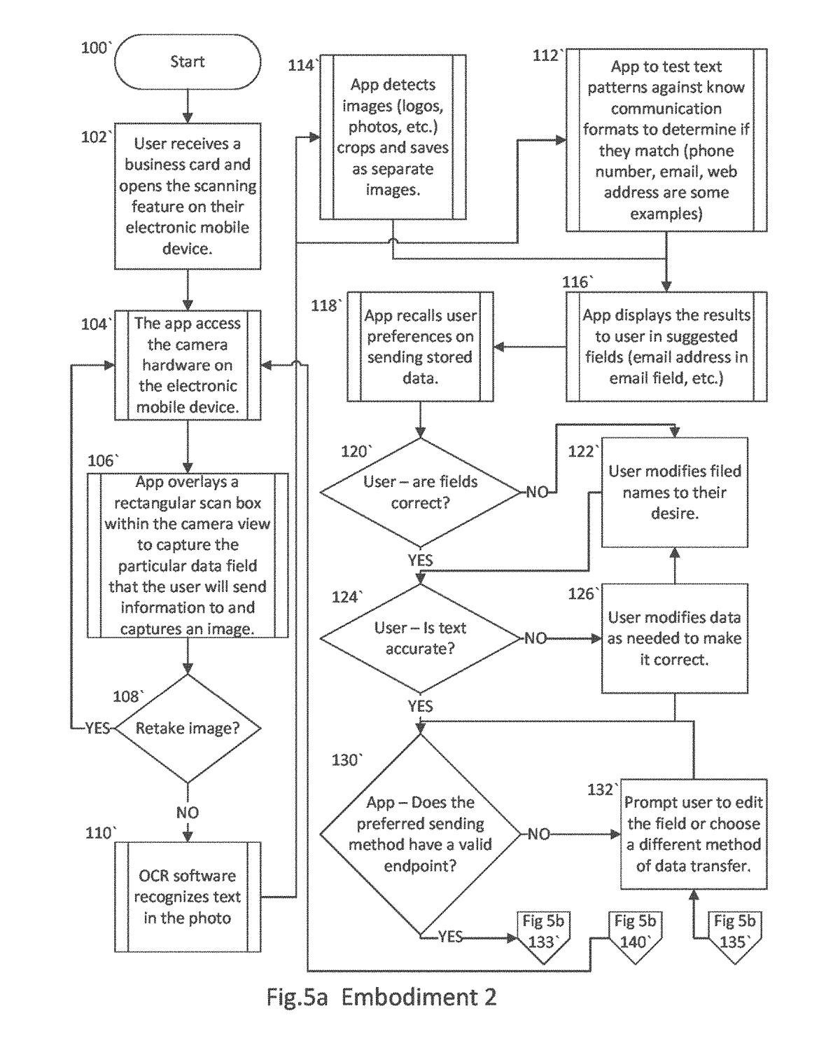

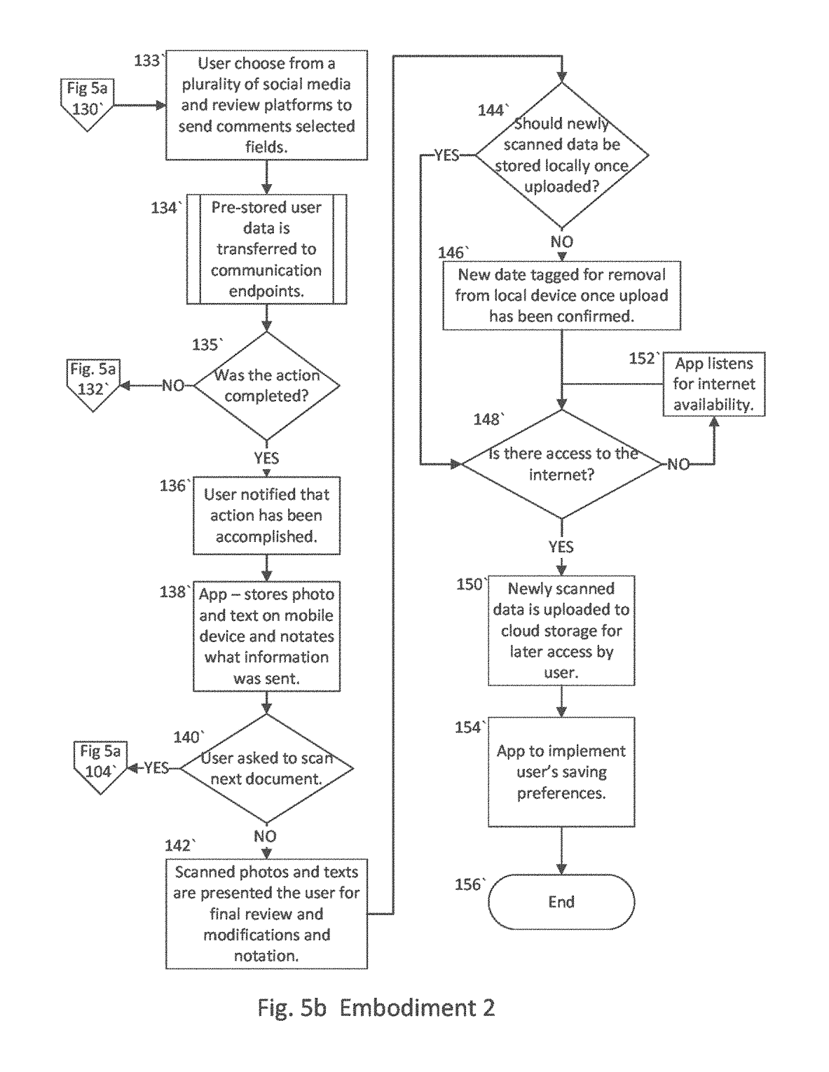

The same methods in the first embodiment can be used with the additional element (133′)(FIG. 5) whereby the user can choose from the list of fields offered in element (126) to share on a plurality of social media and review sites.

### CONCLUSION, RAMIFICATIONS, AND SCOPE

The reader will see that at least one embodiment of the process provides a more efficient, and smoother sharing of digital information, with a party possessing a loosely formatted visual document. Cutting down the time and steps it takes in sharing information not only creates a more professional atmosphere but gives both parties what they are looking for in a timely manner without distracting them from the conversation at hand.

While my above description contains many specific details to illustrate functionality, those details should not be construed as limitations on the scope, but rather as an exemplification of several embodiments thereof. Many other variations are possible. For example, data from badges, receipts, tickets, forms, legal documents, screen, either fixed or mobile, and handwritten notes that displays desired information along with one or more return communication addresses that are generally consistent in formatting can be used for capturing data and sending prestored information back to an endpoint.

Scanning a receipt that has the company email or phone number on it, the user could have a preselected data set that expresses their level of satisfaction back to the company and post it to social media or review site at the same time.

Accordingly, the scope should be determined not by the embodiments illustrated, but by the appended claims and their legal equivalents.

What is claimed is:

1. A method of distributing prestored information comprising the steps of:
using a mobile electronic device with access to said information; using said device for acquiring an image of a document comprised of a text pattern for use as a sending endpoint; using optical character recognition on said acquired image to extract text; reading of said text; testing said text against a plurality of predetermined patterns to identify an endpoint to share said information; and there by sending said information to said endpoint by means of said device.

2. A method as claimed in claim 1, also comprising of the steps of:
acquiring images within said document; displaying said images; and saving said image with labels.

3. A method as claimed in claim 1, further utilizing said text by categorizing said text against a plurality of prestored patterns, saving said text in their appropriate categories based off the patterns that matched.

4. A method as claimed in claim 1, wherein said document is an electronic display.

5. A method as claimed in 1, wherein said endpoint is a cellular text message.

6. A method as claimed in 1, wherein all acquired image information and from said document and notations are uploaded to off-device storage for later use.

7. A method as claimed in 1, wherein said information and said notations are distributed to a plurality of endpoints simultaneously.
